(19) United States
(12) Patent Application Publication
(10) Pub. No.: US 2024/0103142 A1
(43) Pub. Date: Mar. 28, 2024

(54) SPACE MEASUREMENT APPARATUS, METHOD, AND DEVICE, AND COMPUTER-READABLE STORAGE MEDIUM

(71) Applicant: RAYZ TECHNOLOGIES CO. LTD., Beijing (CN)

(72) Inventors: Ruxin Chen, Beijing (CN); Detao Du, Beijing (CN)

(73) Assignee: RAYZ TECHNOLOGIES CO. LTD., Beijing (CN)

(21) Appl. No.: 17/928,219

(22) PCT Filed: May 27, 2021
(86) PCT No.: PCT/CN2021/096352

§ 371 Date: Sep. 7, 2023

(30) Foreign Application Priority Data
May 28, 2020 (CN) 202010465158.1

(51) Int. Cl. G01S 7/487; G01S 17/42; G01S 17/89

(52) U.S. Cl. CPC G01S 7/487; G01S 17/42; G01S 17/89

(57) ABSTRACT

The present disclosure provides a space measuring apparatus. The apparatus includes: a light emitting component configured to: emit a measurement pulse set, in which the measurement pulse set includes at least two pulse strings corresponding to at least two different emitting angles, each pulse string of the at least two pulse strings includes at least one optical pulse with a same emitting angle; and record pulse set characteristics of the measurement pulse set; and a calculation component configured to form at least one to-be-determined pulse set by combining at least two optical pulses received in a second time interval; determine whether the at least one to-be-determined pulse set is valid according to the pulse set characteristics recorded by the light emitting component; and calculate, according to the pulse set characteristics of pulse sets which are determined as valid, at least one of measurement distance and light intensity.

### TECHNICAL FIELD

The present disclosure relates to measurement technology, and in particular, relates to a space measuring apparatus, method, device, and computer readable storage medium.

### BACKGROUND

With the development of automatic driving, assisted driving, 3D video and game box, smart phone navigation, intelligent robot and other applications, it is getting increasingly important to accurately obtain distance information of a target scene in real time.

Laser radar is a radar system that can detect feature information of a target, for example, to obtain a range, azimuth, height, speed, attitude, even shape and other parameters of the target, in order to achieve target detection, tracking, recognition and so on. However, there can be interference information such as sunlight, lamp light, other laser radars and so on in an actual measurement environment of a to-be-measured target scene, which will reduce the measurement accuracy and reliability of the laser radar.

### SUMMARY

In view of the above issues, the present disclosure is proposed. The present disclosure provides a space measurement device, method, device and computer readable storage medium, which are used to realize anti-interference in the process of space measurement, and improve the measurement accuracy and reliability of the laser radar.

According to an aspect of the present disclosure, a space measuring apparatus is provided. The space measuring apparatus includes: a light emitting component including at least one light emitting element, configured to emit a measurement pulse set, wherein the measurement pulse set includes at least two pulse strings corresponding to at least two different emitting angles, each pulse string of the at least two pulse strings includes at least one optical pulse with a same emitting angle, and a maximum time interval covered by optical pulses in a same pulse string is shorter than a first time interval, and the light emitting component is further configured to record pulse set characteristics of the measurement pulse set, wherein the pulse set characteristics include pulse characteristics of optical pulses in the measurement pulse set; a light receiving component including at least one detection element, configured to receive optical pulses reflected or scattered by a target scene, and record pulse characteristics of the received optical pulses; and a calculation component, configured to: form at least one to-be-determined pulse set by combining at least two optical pulses received in a second time interval, wherein the to-be-determined pulse set includes pulse strings corresponding to at least two receiving angles; determine whether the at least one to-be-determined pulse set is valid according to the pulse set characteristics recorded by the light emitting component; and calculate, according to the pulse set characteristics of pulse sets which are determined as valid, at least one of measurement distance and light intensity.

According to embodiments of the present disclosure, the pulse characteristics of optical pulses include a first characteristic and a second characteristic, wherein the first characteristic of an optical pulse emitted by the light emitting component includes an emitting angle and an emitting time; the first characteristic of an optical pulse received by the light receiving component includes a receiving angle and a receiving time; the second characteristic of an optical pulse emitted by the light emitting component and the second characteristic of an optical pulse received by the light receiving component includes at least one of the following: a waveform, a wavelength, a wavelength-time function, polarization, peak intensity, total energy, spatial light intensity distribution; the pulse set characteristics further include: a sequence, a relative time and a relative energy among optical pulses in a pulse string to which the optical pulses belong; a sequence, a relative time and a relative energy among pulse strings in a pulse set to which the pulse strings belong.

According to embodiments of the present disclosure, the light emitting component is further configured to control, except for the emitting angle and the emitting time, the pulse set characteristics of any two measurement pulse sets within a third time interval to be different, wherein the second time interval is shorter than the third time interval.

According to embodiments of the present disclosure, the light emitting component is further configured to control that a time interval between optical pulses in the same emitting angle is not longer than a fourth time interval, wherein the fourth time interval is shorter than a first percentage of a fifth time interval, and the fifth time interval is a time for the apparatus transceiving an optical pulse in a maximum range.

According to embodiments of the present disclosure, the light emitting component is further configured to control to at least emit within a sixth time interval, pulse strings having difference in at least one of the following second characteristics: a waveform, a wavelength, polarization, wherein the sixth time interval is longer than the fifth time interval.

According to embodiments of the present disclosure, the apparatus further includes at least one optical scanning component which is configured to be connected to the light emitting component and/or the light receiving component to drive the light emitting component and/or the light receiving component to scan the target scene.

According to embodiments of the present disclosure, the calculation component is configured to: after the light receiving component receives an optical pulse, search for optical pulses received within the second time interval before receiving said optical pulse and combine the optical pulses to form at least one to-be-determined pulse set; and determine to-be-determined pulse sets with pulse set characteristics matching the pulse set characteristics recorded by the light emitting component as valid pulse sets.

According to embodiments of the present disclosure, when the at least one to-be-determined pulse set received within the second time interval is determined to be an invalid pulse set, the calculation component is further configured to: search for optical pulses received within a seventh time interval before receiving said optical pulse and combine the optical pulses to form at least one extended to-be-determined pulse set; determine to-be-determined extended pulse sets having pulse set characteristics of the to-be-determined extended pulse sets matching the pulse set characteristics recorded by the light emitting component as valid extended pulse sets; determine a ratio of the valid extended pulse sets to the at least one to-be-determined extended pulse set; determine, in response to the ratio is smaller than a second percentage, all the extended pulse sets received within the seventh time interval as invalid extended pulse sets; otherwise, accept the valid extended pulse sets, wherein the seventh time interval is longer than the second time interval.

According to embodiments of the present disclosure, the light emitting component is further configured to control to at least emit within an eighth time interval, pulse strings having difference in at least two of the following second characteristics: a waveform, a wavelength, polarization, wherein the eighth time interval is longer than the fifth time interval, and the second characteristics of any two pulse strings during the eighth time interval are different.

According to embodiments of the present disclosure, the light receiving component is further configured to record a waveform of the received optical pulses based on a combination of the following characteristics: a fixed threshold, a peak intensity, a constant ratio timing intensity, a rising edge time point of the fixed threshold, a falling edge time point of the fixed threshold, a time point of the peak intensity, and a rising edge time point of the constant ratio timing intensity.

According to embodiments of the present disclosure, the fixed threshold and the constant ratio timing intensity are adjusted based on a preset attenuation law.

According to embodiments of the present disclosure, the light receiving component is configured to record a waveform of the received optical pulses based on a plurality of optical intensity data sampled at a fixed time interval or a statistical value of the sampled data.

According to embodiments of the present disclosure, the calculation component is further configured to: determine pixel points belonging to a first adjacent local area from a plurality of target-scene pixel points corresponding to a first search range; for the pixel points belonging to the first adjacent local area, determine a first matching ratio of optical pulses used to calculate measurement distances of the pixel points to the optical pulses emitted by the light emitting component; and accept, in response to the first matching ratio is larger than a first ratio threshold, the measurement distances of the plurality of target-scene pixel points in the first search range and the corresponding optical pulses.

According to embodiments of the present disclosure, the calculation component is further configured to: reject, in response to the first matching ratio is not larger than the first ratio threshold, the measurement distances of the plurality of target-scene pixel points in the first search range and the corresponding optical pulses.

According to embodiments of the present disclosure, the light emitting component is further configured to emit optical pulses to the first search range again to determine the measurement distances of the plurality of target-scene pixel points corresponding to the first search range again.

According to embodiments of the present disclosure, in response to the first matching ratio is larger than the first ratio threshold, the calculation component is further configured to: determine pixel points belonging to a second adjacent local area from a plurality of target-scene pixel points corresponding to a second search range, wherein the second search range is larger than the first search range; for the pixel points belonging to the second adjacent local area, determine a second matching ratio of the optical pulses used to calculate measurement distances of the pixel points to the optical pulses emitted by the light emitting component; accept, in response to the second matching ratio is larger than a second ratio threshold, the measurement distances of the plurality of target-scene pixel points in the second search range and the corresponding optical pulses; and reject, in response to the second matching ratio is not larger than the second ratio threshold, the measurement distances of the plurality of target-scene pixel points in the second search range.

According to embodiments of the present disclosure, for at least one received optical pulse, the calculation component is further configured to output at least one of the following information: corresponding measuring distance, receiving angle, and relative light intensity.

According to embodiments of the present disclosure, the calculation component determining the pixel points belonging to the first adjacent local area includes: fitting a first standard plane based on the measurement distances of the plurality of target-scene pixel points corresponding to the first search range; determining a distance difference between the measurement distances of the plurality of target-scene pixel points corresponding to the first search range and the first standard plane; and determining the pixel points belonging to the first adjacent local area based on the distance difference and a first distance threshold.

According to embodiments of the present disclosure, the calculation component determining the pixel points belonging to the first adjacent local area includes: determining the pixel points belonging to the first adjacent local area from the plurality of target-scene pixel points corresponding to the first search range based on an artificial intelligence recognition model.

According to embodiments of the present disclosure, the apparatus further includes an image acquisition component which is configured to acquire an image of the target scene, wherein the calculation component determining the pixel points belonging to the first adjacent local area further includes: determining the pixel points belonging to the first adjacent local area from the plurality of target-scene pixel points corresponding to the first search range based on the artificial intelligence recognition model and the image of the target scene.

According to embodiments of the present disclosure, the calculation component is further configured to: recognize geometry figures based on the plurality of target-scene pixel points corresponding to the first search range with the artificial intelligence recognition model.

According to embodiments of the present disclosure, the geometry figures include basic graphic elements used in computer graphics systems, games and/or animations.

According to embodiments of the present disclosure, training data for the artificial intelligence recognition model includes real data actually collected and calibrated, or further includes virtual data generated by games and animations.

According to another aspect of the present disclosure, a space measuring method is provided. The method includes: emitting a measurement pulse set, wherein the measurement pulse set includes at least two pulse strings corresponding to at least two different emitting angles, each pulse string of the at least two pulse strings includes at least one optical pulse with a same emitting angle, and a maximum time interval covered by optical pulses in a same pulse string is shorter than a first time interval; recording pulse set characteristics of the measurement pulse set, wherein the pulse set characteristics include pulse characteristics of optical pulses in the measurement pulse set; receiving optical pulses reflected or scattered by a target scene, and recording pulse characteristics of the received optical pulses; forming at least one to-be-determined pulse set by combining at least two optical pulses received in a second time interval, wherein the to-be-determined pulse set includes pulse strings corresponding to at least two receiving angles; determining whether the at least one to-be-determined pulse set is valid according to the recorded pulse set characteristics; and calculating, based on the pulse set characteristics of pulse sets which are determined as valid, at least one of measurement distance and light intensity, and/or outputting information of the pulse sets which are determined as valid.

According to embodiments of the present disclosure, the pulse characteristics of optical pulses include a first characteristic and a second characteristic, wherein the first characteristic of an emitted optical pulse includes an emitting angle and an emitting time; the first characteristic of an received optical pulse includes a receiving angle and a receiving time; the second characteristic of an emitted optical pulse and the second characteristic of an received optical pulse includes at least one of the following: a waveform, a wavelength, a wavelength-time function, polarization, peak intensity, total energy, spatial light intensity distribution; the pulse set characteristics further include: a sequence, a relative time and a relative energy among optical pulses in a pulse string to which the optical pulses belong; a sequence, a relative time and a relative energy among pulse strings in a pulse set to which the pulse strings belong.

According to embodiments of the present disclosure, the method further includes: controlling, except for the emitting angle and the emitting time, the pulse set characteristics of any two measurement pulse sets within a third time interval to be different, wherein the second time interval is shorter than the third time interval.

According to embodiments of the present disclosure, the method further includes: controlling that a time interval between optical pulses in the same emitting angle is not longer than a fourth time interval, wherein the fourth time interval is shorter than a first percentage of a fifth time interval, and the fifth time interval is a time for a space measuring apparatus transceiving an optical pulse in a maximum range.

According to embodiments of the present disclosure, the method further includes: controlling to at least emit within a sixth time interval, pulse strings having difference in at least one of the following second characteristics: a waveform, a wavelength, polarization, wherein the sixth time interval is longer than the fifth time interval.

According to embodiments of the present disclosure, the method further includes: after receiving an optical pulse, searching for optical pulses received within the second time interval before receiving said optical pulse and combining the optical pulses to form at least one to-be-determined pulse set; and determining to-be-determined pulse sets with pulse set characteristics matching the recorded pulse set characteristics as valid pulse sets.

According to embodiments of the present disclosure, when the at least one to-be-determined pulse set received within the second time interval is determined to be an invalid pulse set, the method further includes: searching for optical pulses received within a seventh time interval before receiving said optical pulse and combining the optical pulses to form at least one extended to-be-determined pulse set; determining to-be-determined extended pulse sets having pulse set characteristics of the to-be-determined extended pulse sets matching the recorded pulse set characteristics as valid extended pulse sets; determining a ratio of the valid extended pulse sets to the at least one to-be-determined extended pulse set; determining, in response to the ratio is smaller than a second percentage, all the extended pulse sets received within the seventh time interval as invalid extended pulse sets; otherwise, accepting the valid extended pulse sets, wherein the seventh time interval is longer than the second time interval.

According to embodiments of the present disclosure, the method further includes: controlling to at least emit within an eighth time interval, pulse strings having difference in at least two of the following second characteristics: a waveform, a wavelength, polarization, wherein the eighth time interval is longer than the fifth time interval, and the second characteristics of any two pulse strings during the eighth time interval are different.

According to embodiments of the present disclosure, the method further includes: recording a waveform of the received optical pulses based on a combination of the following characteristics: a fixed threshold, a peak intensity, a constant ratio timing intensity, a rising edge time point of the fixed threshold, a falling edge time point of the fixed threshold, a time point of the peak intensity, and a rising edge time point of the constant ratio timing intensity.

According to embodiments of the present disclosure, the fixed threshold and the constant ratio timing intensity are adjusted based on a preset attenuation law.

According to embodiments of the present disclosure, the method further includes: recording a waveform of the received optical pulses based on a plurality of optical intensity data sampled at a fixed time interval or a statistical value of the sampled data.

According to embodiments of the present disclosure, the method further includes: determining pixel points belonging to a first adjacent local area from a plurality of target-scene pixel points corresponding to a first search range; for the pixel points belonging to the first adjacent local area, determining a first matching ratio of optical pulses used to calculate measurement distances of the pixel points to the emitted optical pulses; and accepting, in response to the first matching ratio is larger than a first ratio threshold, the measurement distances of the plurality of target-scene pixel points in the first search range and the corresponding optical pulses.

According to embodiments of the present disclosure, the method further includes: rejecting, in response to the first matching ratio is not larger than the first ratio threshold, the measurement distances of the plurality of target-scene pixel points in the first search range and the corresponding optical pulses.

According to embodiments of the present disclosure, the method further includes: emitting optical pulses to the first search range again to determine the measurement distances of the plurality of target-scene pixel points corresponding to the first search range again.

According to embodiments of the present disclosure, in response to the first matching ratio is larger than the first ratio threshold, the method further includes: determining pixel points belonging to a second adjacent local area from a plurality of target-scene pixel points corresponding to a second search range, wherein the second search range is larger than the first search range; for the pixel points belonging to the second adjacent local area, determining a second matching ratio of the optical pulses used to calculate measurement distances of the pixel points to the emitted optical pulses accepting, in response to the second matching ratio is larger than a second ratio threshold, the measurement distances of the plurality of target-scene pixel points in the second search range and the corresponding optical pulses; and rejecting, in response to the second matching ratio is not larger than the second ratio threshold, the measurement distances of the plurality of target-scene pixel points in the second search range.

According to embodiments of the present disclosure, for at least one received optical pulse, the method further includes: outputting at least one of the following information: corresponding measuring distance, receiving angle, and relative light intensity.

According to embodiments of the present disclosure, the determining the pixel points belonging to the first adjacent local area includes: fitting a first standard plane based on the measurement distances of the plurality of target-scene pixel points corresponding to the first search range; determining a distance difference between the measurement distances of the plurality of target-scene pixel points corresponding to the first search range and the first standard plane; and determining the pixel points belonging to the first adjacent local area based on the distance difference and a first distance threshold.

According to embodiments of the present disclosure, the determining the pixel points belonging to the first adjacent local area includes: determining the pixel points belonging to the first adjacent local area from the plurality of target-scene pixel points corresponding to the first search range based on an artificial intelligence recognition model.

According to embodiments of the present disclosure, the method further includes: acquiring an image of the target scene, wherein the determining the pixel points belonging to the first adjacent local area further includes: determining the pixel points belonging to the first adjacent local area from the plurality of target-scene pixel points corresponding to the first search range based on the artificial intelligence recognition model and the image of the target scene.

According to embodiments of the present disclosure, the method further includes: recognizing geometry figures based on the plurality of target-scene pixel points corresponding to the first search range with the artificial intelligence recognition model.

According to embodiments of the present disclosure, the geometry figures include basic graphic elements used in computer graphics systems, games and/or animations.

According to embodiments of the present disclosure, training data for the artificial intelligence recognition model includes real data actually collected and calibrated, or further includes virtual data generated by games and animations.

According to yet another aspect of the present disclosure, a space measuring device is provided. The space measuring device includes a processor; and a memory with computer-readable code stored thereon, wherein the computer-readable code, when executed by the processor, performs the above-mentioned space measuring method.

According to yet another aspect of the present disclosure, a computer-readable storage medium with instruction stored thereon is provided. The instructions, when executed by a processor, case the processor to perform the above-mentioned space measuring method.

As will be described in detail below, in the space measuring apparatus and method according to the embodiments of the present disclosure, a measurement pulse set is emitted by the light emitting component, the measurement pulse set includes at least two pulse strings corresponding to at least two different emitting angles, and each of the pulse strings includes at least one optical pulse with the same emitting angle. A valid pulse set is determined based on the recorded pulse set characteristics of the measurement pulse set. The measurement distance of the pixel points in the target scene is calculated based on the pulse set determined as valid, and thus, anti-interference in the process of space measuring can be achieved, and the measurement accuracy and measurement reliability of the laser radar can be improved.

It is to be understood that the above general descriptions and the below detailed descriptions are merely exemplary and explanatory, and are not intended to limit the present disclosure.

### BRIEF DESCRIPTION OF THE DRAWINGS

In order to explain the embodiments of the present disclosure or the technical solutions in the prior art more clearly, the following will briefly introduce the drawings to be used in the description of the embodiments or the prior art. Apparently, the drawings in the following description are only parts of embodiments of the present disclosure. For those ordinary skilled in the art, other drawings can also be obtained based on these drawings without paying creative labor.

FIG. 1 shows a schematic diagram of an application scenario of a space measuring apparatus according to embodiments of the present disclosure;

FIG. 2 shows a schematic diagram of pulse strings and a measurement pulse set according to embodiments of the present disclosure;

FIG. 3 shows a schematic diagram of a waveform according to embodiments of the present disclosure;

FIG. 4 shows a flowchart of a space measuring method according to embodiments of the present disclosure;

FIG. 5 shows a schematic diagram of a space measuring device according to embodiments of the present disclosure;

FIG. 6 shows a schematic diagram of an architecture of an exemplary computing device according to embodiments of the present disclosure;

FIG. 7 shows a schematic diagram of a storage medium according to embodiments of the present disclosure.

### DETAILED DESCRIPTION

The technical solutions in the embodiments of the present disclosure will be described clearly and completely with reference to the drawings in the embodiments of the present disclosure. Apparently, the described embodiments are only part of the embodiments of the present disclosure, not all of them. Based on the embodiments in the present disclosure, all other embodiments obtained by those ordinary skilled in the art without creative labor belong to the scope of the present disclosure.

The terms “first”, “second” and similar terms used in the present disclosure do not indicate any order, amount or importance, but are only used to distinguish different components. Similarly, terms such as “including” or “including” mean that elements or objects appearing before the term cover elements or objects listed after the term and their equivalents, without excluding other elements or objects. Terms such as “connecting” or “connection” are not limited to physical or mechanical connection, but can include electrical connection, whether direct or indirect.

Flowcharts are used in the present disclosure to illustrate the steps of the method according to the embodiments of the present disclosure. It should be understood that previous or subsequent steps are not necessarily carried out in a precise order. Instead, the various steps can be processed in reverse order or simultaneously. Also, it is possible to add other operations to these procedures, or skip a step or several steps from these procedures.

In the field of space measurement, a measurement system such as a laser radar sends optical pulses to a target scene, and calculates a measurement distance and other parameters based on the optical pulses reflected by the current scene. However, as mentioned above, in an actual measurement scene, in addition to the optical pulses emitted by the current laser radar system, there are also various interference signals, such as sunlight, light, optical pulses emitted by other laser radar systems, and even the optical pulses emitted by the current laser radar system in the previous measurement period. In other words, for the current laser radar system, except for the optical pulses emitted in the current measurement period reflected by the current scene, the other received optical signals are interference signals. If the laser radar system fails to identify these interference signals and determine valid measurement signals, the calculated measurement values will be inaccurate, reducing the reliability of the measurement. For example, in the field of assisted driving, if the distance information obtained by a laser radar and other measurement systems has large errors, it will lead to inappropriate or even wrong suggestions for assisted driving, reducing the reliability of assisted driving. Therefore, in the field of space measurement, it is significant to achieve anti-interference to improve the accuracy of measurement.

The present disclosure provides a space measuring apparatus for realizing anti-interference in the process of space measuring. Specifically, the space measuring apparatus according to the embodiments of the present disclosure can determine a valid pulse set based on pulse set characteristics of a measurement pulse set composed of pulse strings emitted by at least two emitting angles, and calculate a measurement distance of pixel points in the target scene based on the determined valid pulse set, so as to avoid the influence of invalid optical pulses (i.e., interference signals) on the measurement results, therefore, the measurement accuracy and reliability of the laser radar can be improved.

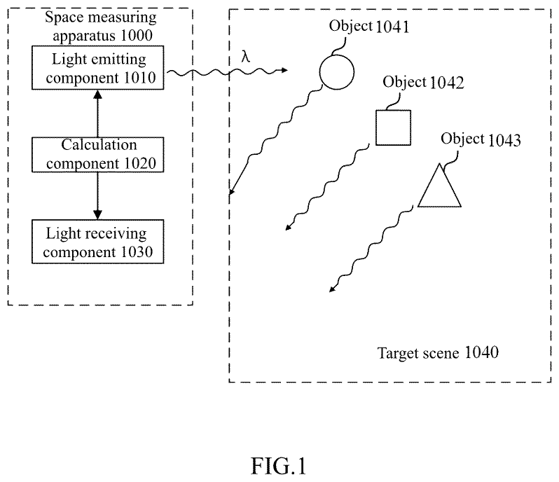

FIG. 1 shows a schematic diagram of an application scenario of a space measuring apparatus according to embodiments of the present disclosure. The application scenario of the present disclosure and the implementation process of the space measuring apparatus according to the embodiments of the present disclosure will be described below with reference to FIG. 1.

As shown in FIG. 1, a space measuring apparatus 1000 according to the embodiment of the present disclosure performs distance measurement for a target scene (or a to-be-measured scene) 1040. As schematically shown in FIG. 1, the target scene can include objects 1041, 1042, and 1043 at different positions, and the objects 1041, 1042, and 1043 can be composed of object points (or pixel points). As an example, the space measuring apparatus 1000 can be implemented in an automatic driving system. The space measuring apparatus 1000 measures a relative distance of objects encountered in a driving process of a vehicle (for example, streets, highways, etc.), and the distance information obtained will be used for positioning, driving area detection, lane marking line detection, obstacle detection, dynamic object tracking, obstacle classification and recognition and other functions for unmanned vehicles. As another example, the space measuring apparatus 1000 can be implemented in an AR/VR video game system. The space measuring apparatus 1000 measures distance information in an environment around a user, in order to accurately locate a position of the user in a three-dimensional space and enhance a game experience of reality. As another example, the space measuring apparatus 1000 can also be implemented in an intelligent robot system. The space measuring apparatus 1000 measures scene distance information of a working environment of the robot, thereby realizing modeling of the working environment and intelligent path planning for the robot.

As schematically shown in FIG. 1, the space measuring apparatus 1000 according to the embodiments of the present disclosure includes a light emitting component 1010, a calculation component 1020, and a light receiving component 1030. The light emitting component 1010 can include at least one light emitting element for emitting optical pulses at a wavelength of k, to illuminate a target scene 1040. The light receiving component 1030 can include at least one detection element for receiving optical pulses reflected or scattered by the target scene. In addition, it should be understood that the specific parameters and implementation methods of the light emitting component 1010 and the light receiving component 1030 will not constitute restriction on the scope of the present disclosure, and any combination of light emitting elements and detection elements that can realize the space measuring apparatus and method according to the embodiments of the present disclosure are included in the scope of the present disclosure.

The calculation component 1020 can be connected to the light emitting component 1010 and the light receiving component 1030 in a wired or wireless manner, to calculate a measurement distance of pixel points in the target scene based on optical pulses emitted by the light emitting component 1010 and optical pulses received by the light receiving component 1030. For the space measuring apparatus 1000, the calculation component 1020 is required to identify a received optical pulse to determine an emitted optical pulse corresponding to the received optical pulse. In the present disclosure, the optical pulse emitted by the light emitting component 1010, which is referred to as the emitted optical pulse or the measurement optical pulse, is reflected by the pixel points in the target scene and is received by the light receiving component 1030, which is referred to as the received optical pulse. The emitted optical pulse and the received optical pulse constitute a set of measurement pulses. Based on the set of measurement pulses, distance information of the pixel points in the current scene can be determined. For example, the distance information of the pixel points is calculated based on a time difference between the measurement pulses. Therefore, after the light receiving component 1030 receives the optical pulse, the calculation component 1020 is required to identify the emitted optical pulse corresponding to the received optical pulse. If a corresponding emitted optical pulse can be identified, it means that the received optical pulse is a valid measurement signal and can be used for the distance calculation; if no corresponding emitted optical pulse is identified, it means that the received optical pulse is an invalid measurement signal (for example, interference signal) and cannot be used for distance calculation.

According to the embodiments of the present disclosure, the space measuring apparatus 1000 can also include at least one optical scanning component (not shown in FIG. 1). The optical scanning component is configured to be connected to the light emitting component and/or the light receiving component, to drive the light emitting component and/or the light receiving component to scan the target scene. In addition, it should be understood that the specific parameters of the optical scanning component and the implementation method will not constitute a limitation on the scope of the present disclosure, and any scanning element and its combination that can realize the space measuring apparatus and method according to the embodiments of the present disclosure are included in the scope of the present disclosure.

The specific measuring process according to the space measuring apparatus of the present disclosure will be described in detail below.

According to embodiments of the present disclosure, the light emitting component is configured to emit a measurement pulse set. The measurement pulse set includes at least two pulse strings corresponding to at least two different emitting angles, and each of the pulse strings includes at least one optical pulse with a same emitting angle. For example, an optical pulse refers to an optical signal with continuous non-zero intensity within a time period, which is usually a few picoseconds, a few nano-seconds or a few microseconds, which is not limited herein. The measurement pulse set represents a combination of a series of optical pulses emitted by the light emitting component for space measuring.

According to the embodiments of the present disclosure, the at least two different emitting angles represent two or more different emitting angles, such as an emitting angle A, an emitting angle B, an emitting angle C. For example, the light emitting component can implement the at least two different emitting angles through fixed light emitting elements arranged therein, or can also implement the at least two different emitting angles through the scanning component connected thereto. The measurement pulse set includes at least two pulse strings corresponding to at least two different emitting angles, that is, the pulse set for measurement includes two or more pulse strings, and these two or more pulse strings correspond to at least two different emitting angles. As an example, a measurement pulse set 1 can at least include a pulse string A and a pulse string B, wherein the pulse string A corresponds to an emitting angle A, and the pulse string B corresponds to an emitting angle B, that is, this measurement pulse set includes at least two pulse strings corresponding to at least two different emitting angles (i.e., the emitting angle A and the emitting angle B). As another example, a measurement pulse set 2 includes, in addition to the pulse string A and the pulse string B, a pulse string C, and the pulse string C corresponds to an emitting angle C. In this example, the measurement pulse set 2 includes three pulse strings corresponding to three different emitting angles. As another example, in addition to the pulse string A and pulse string B, a measurement pulse set 3 includes a pulse string D, and the pulse string D corresponds to the emitting angle A. In this example, the measurement pulse set 3 includes three pulse strings corresponding to two different emitting angles. In general, the measurement pulse set includes at least two pulse strings corresponding to at least two different emitting angles.

According to the embodiments of the present disclosure, the maximum time interval covered by optical pulses in the same pulse string is shorter than a first time interval. The first time interval represents the maximum time interval between optical pulses in a pulse string. For example, for a pulse string including an optical pulse A (corresponding to t_{A}), an optical pulse B (corresponding to t_{B}), and an optical pulse C (corresponding to t_{C}), where t_{A}<t_{B}<t_{C}, the maximum time interval covered by the optical pulses in the pulse string represents the time interval between t_{A} and t_{C}. In practical application, the first time interval can be set to a smaller value to improve the measurement efficiency, for example, it can be 100 ns.

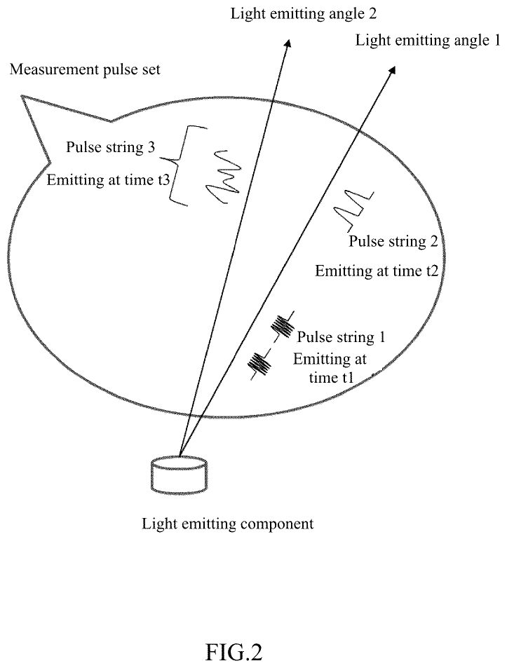

FIG. 2 schematically shows a schematic diagram of pulse strings and a pulse set according to embodiments of the present disclosure. The light emitting component can be configured to emit pulse strings respectively toward an emitting angle 1 and an emitting angle 2 within a time interval. For example, the light emitting component emits a pulse string 1 toward the emitting angle 1 at time t1, the pulse string 1 including two optical pulses at the same emitting time and toward the same emitting angle; emits a pulse string 2 toward the emitting angle 1 at time t2; and emits a pulse string 3 toward the emitting angle 2 at time t3, where t3=t2. The pulse strings 1-3 shown in FIG. 2 can form a measurement pulse set.

According to the embodiments of the present disclosure, the light emitting component is also configured to record pulse set characteristics of the measurement pulse set, wherein the pulse set characteristics include pulse characteristics of the optical pulses in the measurement pulse set. According to the embodiments of the present disclosure, the pulse characteristics of the emitted optical pulse include first characteristics and second characteristics. Specifically, the first characteristics of the emitted optical pulse include an emitting angle and an emitting time. In addition, the second characteristics of the emitted optical pulse include, but are not limited to, at least one of the following: a waveform, a wavelength, a wavelength-time function, polarization, peak intensity, total energy, and spatial light intensity distribution. The wavelength-time function corresponds to a chirped pulse.

In addition, the pulse set characteristics of the measurement pulse set not only include the pulse characteristics of the optical pulses in the measurement pulse set, but further include relative characteristics among pulse strings in the measurement pulse set. For example, sequence, relative time, relative energy among the pulse strings in the pulse set to which they belong, or also include relative characteristics among the optical pulses in the pulse strings, for example, sequence, relative time, relative energy among the optical pulses in the pulse string to which they belong. The recorded pulse set characteristics of the measurement pulse set can be used to identify whether a received optical pulse is a valid measurement pulse to achieve anti-interference.

According to the embodiments of the present disclosure, the light receiving component can be configured to receive optical pulses reflected or scattered by the target scene, and record pulse characteristics of the received optical pulses. Similar to the emitted optical pulse, pulse characteristics of a received optical pulse also include first characteristics and second characteristics. Correspondingly, the first characteristics of the received optical pulse include a receiving angle and a receiving time. The second characteristics of the received optical pulse include, but are not limited to, at least one of the following: a waveform, a wavelength, a wavelength-time function, polarization, peak intensity, total energy, and spatial light intensity distribution. It should be noted that the second characteristics of the received optical pulse are consistent with those of the emitted optical pulse. For example, when the second characteristics of the emitted optical pulse include a waveform and a wavelength, the second characteristics of the received optical pulse also include a waveform and a wavelength.

According to the embodiments of the present disclosure, the calculation component can be configured to form at least one to-be-determined pulse set by combining at least two optical pulses received in a second time interval, wherein the to-be-determined pulse set include pulse strings corresponding to at least two receiving angles. The second time interval represents a searching time range for receiving optical pulses, for example, it can be set to 3 μs. According to the embodiments of the present disclosure, the calculation component determines whether the at least one to-be-determined pulse set is valid according to the pulse set characteristics recorded by the light emitting component, and calculates at least one of measurement distance and light intensity based on the pulse set characteristics of a to-be-determined pulse set which are determined as valid.

For example, the calculation component may form one or more to-be-determined pulse sets based on the optical pulses received within the second time interval, and determine the validity of the formed to-be-determined pulse sets one by one. For a to-be-determined pulse set that is determined as invalid, it means that no measurement pulse set corresponding to the characteristics of said pulse set can be identified, that is, this to-be-determined pulse set may include interference signals. For a to-be-determined pulse set that is determined as valid, it means that a measurement pulse set corresponding to the characteristics of said pulse set can be found, that is, the optical pulses included in this to-be-determined pulse set can be used for space measuring. In addition, the calculation component can calculate a space distance of the target scene based on the to-be-determined pulse set that is determined to be valid, that is, carry out space measuring, and can also calculate a relative light intensity of the target scene based on the to-be-determined pulse set that is determined to be valid, which is not limited herein.

According to the embodiments of the present disclosure, the calculation component can also be configured to output information of the pulse set that is determined to be valid, for example, the first and second characteristics of optical pulses, the relative characteristics among pulse strings included in the pulse set, and other information.

As an example, the calculation component can be configured to: after the light receiving component receives an optical pulse, search for optical pulses received in the second time interval before receiving said optical pulse and combine the optical pulses to form at least one to-be-determined pulse set, and determine to-be-determined pulse sets with pulse set characteristics matching the pulse set characteristics recorded by the light emitting component as valid pulse sets. The matching can mean that the characteristics are completely consistent, or a matching degree can be set based on an actual measurement environment. For example, considering that the optical pulse is affected by various factors in the transmission process, its second characteristics can be changed or shifted, for example, the waveform, peak intensity, total energy, spatial light intensity distribution and other characteristics of the optical pulse can be changed in the transmission process, and the degree of matching can be adjusted based on the degree of change.

After the light receiving component receives a current optical pulse, it can determine a plurality of optical pulses received within a time interval of 3 μs before receiving the current optical pulse, and combine the plurality of optical pulses to obtain at least one to-be-determined pulse set. Since the light receiving component records the pulse characteristics of each optical pulse in the process of receiving the optical pulse, it can determine the pulse characteristics of the optical pulse included in the to-be-determined pulse set, and further determine the relative characteristics among the pulse strings in the to-be-determined pulse set, and the relative characteristics among the optical pulses in each pulse string, that is, obtain the pulse string characteristics of the to-be-determined pulse set.

For the to-be-determined pulse set containing the current optical pulse, the pulse set characteristics of the to-be-determined pulse set can be matched with the pulse set characteristics of the measurement pulse set recorded by the light emitting component. If pulse set characteristics of the to-be-determined pulse set and the pulse set characteristics of the measurement pulse set are matched, it means that the received pulse set is valid and can be used to calculate the measurement distance, otherwise the to-be-determined pulse set is invalid and can be discarded (that is rejected).

According to the embodiments of the present disclosure, the light emitting component can also be configured to control, except for the emitting angle and the emitting time, the pulse set characteristics of any two pulse sets within a third time interval to be different, wherein the second time interval is shorter than the third time interval. The third time interval is used to limit a time interval with which the pulse set characteristics of the measurement pulse sets are different from each other, that is, to ensure that the measurement pulse sets with the emitting time interval shorter than the third time interval have distinguishable characteristics, and the second time interval corresponding to the time search range of the identification stage is shorter than the third time interval. Thus, it is ensured that the calculation component can identify different measurement pulse sets sent by the current space measuring apparatus based on the pulse set characteristics recorded by the light emitting component, that is, to achieve an anti-interference effect on the optical signal from the space measuring apparatus.

According to the embodiments of the present disclosure, the light emitting component is also configured to control that a time interval between optical pulses within the same emitting angle is not longer than a fourth time interval, wherein the fourth time interval is shorter than a first percentage of a fifth time interval, and the fifth time interval is a time for the apparatus transceiving an optical pulse in the maximum range. The fourth time interval represents the maximum time interval between optical pulses. Generally, the fourth time interval can be set to a smaller value to improve the reaction speed of the measurement system. In addition, according to the embodiments of the present disclosure, the fourth time interval is also set to be shorter than the first percentage (for example, 30%) of the fifth time interval, that is, the maximum time interval between optical pulses is set to be shorter than the time for the apparatus transmitting an optical pulse in the maximum range. As an example, the fourth time interval can be 20 ns, and the fifth time interval can be 2 μs.

According to the embodiments of the present disclosure, the light emitting component is also configured to control to at least emit within a sixth time interval, pulse strings having difference in at least one of the following second characteristics: a waveform, a wavelength, polarization, wherein the sixth time interval is longer than the fifth time interval. The sixth time interval represents the maximum non-repetition interval of the pulse strings, and the maximum non-repetition interval is longer than the time for the apparatus transmitting an optical pulse in the maximum range. In other words, the pulse strings within the sixth time interval are distinguishable in characteristics. In addition, the waveform includes but is not limited to triangle, square, sine, pulse width, rise and fall width, etc.

According to the embodiments of the present disclosure, when one of the to-be-determined pulse sets received in the second time interval is determined to be a valid pulse set, all the optical pulses in the to-be-determined pulse set can be accepted, that is, the optical pulses in the to-be-determined pulse set are valid measurement signals, which can be used to calculate the measurement distance of pixel points of corresponding angles in the target scene. In addition, according to some embodiments of the present disclosure, the calculation component can also calculate an average value of a plurality of measurement distances corresponding to pixel points at the same angle to correct the measurement distance, to further improve the accuracy of the measurement results.

According to the embodiments of the present disclosure, when all of the at least one to-be-determined pulse set received in the second time interval is determined to be an invalid pulse set, that is, no matching measurement pulse set can be determined, the calculation component is further configured to search for optical pulses received in a seventh time interval before receiving said optical pulse and combine optical pulses to form at least one to-be-determined extended pulse set, wherein the seventh time interval is longer than the second time interval, for example, the seventh time interval can be twice of the second time interval.

In this embodiment, if the calculation component fails to determine a valid measurement signal within the second time interval, the time search range can be appropriately expanded and to-be-determined extended pulse sets can be formed by combination. Similar to the to-be-determined pulse set, the calculation component can determine valid extended pulse sets based on the pulse set characteristics of the to-be-determined extended pulse sets and the pulse set characteristics of the measurement pulse sets. Then, the calculation component can determine a ratio of the valid extended pulse sets to the at least one to-be-determined extended pulse set. When the ratio is smaller than a second percentage, the calculation component can determine all the extended pulse sets received in the seventh time interval as invalid extended pulse sets; otherwise, accept the valid extended pulse sets. As an example, the second percentage can be set based on the actual measurement requirements, for example, the second percentage can be 70%, that is, when for less than 70% of the received optical pulses cannot be matched with the emitted optical pulses, all optical pulses within the seventh time interval are rejected. Thus, the validity of the optical pulses used to calculate the measurement distance can be guaranteed, that is, the anti-interference can be realized. For another example, when the ratio is not less than the second percentage, the valid extended pulse set can be accepted, that is, for calculating distance and/or light intensity.

According to some embodiments of the present disclosure, the light emitting component is also configured to control to at least emit within an eighth time interval, pulse strings having difference in at least two of the following second characteristics: a waveform, a wavelength, polarization, wherein the eighth time interval is longer than the fifth time interval, and the second characteristics of any two pulse strings during the eighth time interval are different.

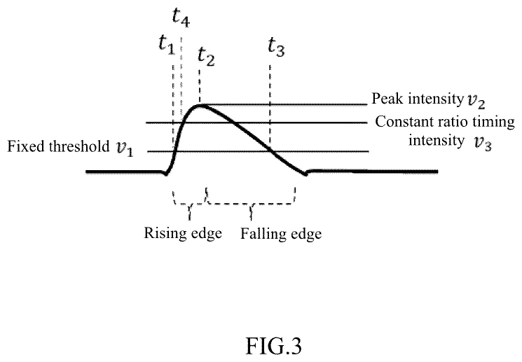

According to an embodiment of the present disclosure, the light receiving component is configured to record the waveform of the received optical pulse based on a combination of the following characteristics: a fixed threshold, a peak intensity, a constant ratio timing intensity, a rising edge time point of a fixed threshold, a falling edge time point of a fixed threshold, a time point of a peak intensity, and a rising edge time point of a constant ratio timing intensity. In other words, the light receiving component can describe the waveform of the received optical pulse based on the above information. FIG. 3 shows a schematic diagram of a waveform according to an embodiment of the present disclosure, in which a fixed threshold v₁, a peak intensity v₂, a constant ratio timing intensity v₃, a rising edge time point t₁ of a fixed threshold, a falling edge time point t₂ of a fixed threshold, a time point t₂, of a peak intensity, and a rising edge time point t₄ of a constant ratio timing intensity are shown. The fixed threshold and the constant ratio timing intensity can be uniformly expressed as the shape threshold, that is, the threshold used to determine the waveform of the optical pulse.

As an example, the space measuring apparatus can determine the waveform of an optical pulse based on [t₁, t₂, t₃, v₁, v₂]. As another example, the space measuring apparatus can determine the waveform of an optical pulse based on [t₁, t₂, t₃, t₄, v₁, v₂, v₃]. As another example, the space measuring apparatus can determine the waveform of an optical pulse based on at least two elements in [t₁, t₂, t₃, t₄] and at least one element in [v₁, v₂, v₃].

In this embodiment, the fixed threshold v₁, the peak intensity v₂, the constant ratio timing intensity v₈ are adjusted based on a preset attenuation law. As described above, in the process of transmitting an optical pulse, the intensity of the optical pulse will be attenuated, and the above intensity used to describe the waveform can be determined based on the attenuation law of light intensity.

According to another embodiment of the present disclosure, the light receiving component is configured to record the waveform of the received optical pulse based on a plurality of optical intensity data or a statistical value of sampled data sampled at a fixed time interval.

According to the embodiments of the present disclosure, the calculation component can also be configured to improve the accuracy of measuring distance based on adjacent areas. For example, after calculating measurement distances of a plurality of target-scene pixel points according to the above description, it is also possible to determine adjacent areas based on the calculated measurement distances, and determine whether the optical pulse can be accepted based on a matching degree corresponding to an optical pulse in the adjacent area. For another example, according to the solution of the present disclosure, the measurement distances can also be calculated based on all received optical pulses, and then the adjacent areas can be determined based on the calculated measurement distances.

Specifically, according to the embodiments of the present disclosure, the calculation component is configured to determine pixel points belonging to a first adjacent local area from a plurality of target-scene pixel points corresponding to the first search range. For example, the first search range can be one-dimensional or two-dimensional spatial angle range Δθ₁. The calculation component first determines a plurality of target-scene pixel points corresponding to Δθ₂, and determines a first adjacent local area from the plurality of target-scene pixel points. For another example, the first search range can be a scanning time range Δt₂, that is, the calculation component first determines in the scanning time range Δt₁, a plurality of target-scene pixel points, and determines a first adjacent local area from the plurality of target-scene pixel points. The process of determining a first adjacent local area will be described below.

Next, the calculation component determines a first matching ratio of the optical pulses used to calculate the measurement distances of the pixel points to the optical pulses emitted by the light emitting component. When the first matching ratio is larger than a first ratio threshold, the calculation component accepts the measurement distances of the plurality of target-scene pixel points in the first search range and the corresponding optical pulses. For a received optical pulse, if an emitted optical pulse corresponding to the pulse characteristics of the received optical pulse is found, it means that the matching is successful, that is, the received optical pulse is a valid measurement signal; if no emitted optical pulse corresponding to the pulse characteristics of the received optical pulse is found, it means that the matching is failed, that is, the received optical pulse is an invalid measurement signal, that is, an interference signal. Thus, the calculation component can determine the first matching ratio of the optical pulses in the first adjacent local area. If the first matching ratio is larger than the first ratio threshold, it means that the matching ratio of the optical pulses in the first adjacent local area meets the requirement, that is, including valid measurement signals that meet the matching ratio, the measurement distances and corresponding optical pulses of plurality of target-scene pixel points in the first search range can be accepted.

According to the embodiments of the present disclosure, the calculation component is also configured to reject the measurement distances of the plurality of target-scene pixel points in the first search range and the corresponding optical pulses when the first matching ratio is not larger than the first ratio threshold, that is, the matching ratio of optical pulses in the first adjacent local area does not meet the requirement. Further, the light emitting component is configured to emit optical pulses to the first search range again to determine the measurement distances of the plurality of target-scene pixel points corresponding to the first search range again.

Through the above process, the calculation result of the distance information of the pixel points can be further determined by determining the first adjacent local area, so as to ensure the accuracy of the distance measurement value and provide the reliability of the measuring apparatus.

According to the embodiments of the present disclosure, when the first matching ratio is greater than the first ratio threshold, the calculation component can be further configured to determine the pixel points belonging to a second adjacent local area from a plurality of target-scene pixel points corresponding to a second search range, wherein the second search range is larger than the first search range. In other words, when it is determined that the optical pulse within the first search range meets the predetermined condition, the calculation component can also expand the search range and determine the matching ratio of the pixel points within the expanded search range.

Specifically, the calculation component can be configured to perform the following steps: for the pixel points belonging to the second adjacent local area, determining a second matching ratio of the optical pulses used to calculate the measurement distances of the pixel points to the optical pulses emitted by the light emitting component; when the second matching ratio is larger than the second ratio threshold, accepting the measurement distances of the plurality of target-scene pixel points in the second search range and the corresponding optical pulses; and when the second matching ratio is not larger than the second ratio threshold, rejecting the measurement distances of the plurality of target-scene pixel points in the second search range. Wherein the second ratio threshold can be the same as or different from the first ratio threshold, which is not limited herein. In addition, the above process of determining the matching ratio of the second search range is similar to the process of determining the matching ratio of the first search range, which will not be described again.

According to the embodiments of the present disclosure, for at least one received optical pulse, the calculation component is also configured to output at least one of the following information: corresponding measurement distance, receiving angle, and relative light intensity. In these embodiments, the space measuring apparatus can determine the optical pulses within the first search range and the second search range: if both meet the ratio requirements, the measurement distances within the second search range can be considered accurate, without having to scan and range again. Thus, the calculated measurement distances and the information of optical pulses used to calculate the measurement distances, such as receiving angle, relative light intensity, etc., can be output.

According to the embodiments of the present disclosure, the first adjacent local area represents a distance adjacent local area in the target scene. For example, the target scene can include a plurality of pixel points, each of the pixel points has a corresponding depth distance, and an area formed by pixel points whose relative distance between the pixel points is less than a preset distance threshold constitutes a distance adjacent local area. Hereinafter, the process of obtaining the distance adjacent local area, that is, the first adjacent local area, will be described in detail.

According to an embodiment of the present disclosure, the calculation component can determine pixel points belonging to the first adjacent local area by plane and/or curve surface fitting. First, the calculation component fits a first standard surface based on the measurement distances of the plurality of target-scene pixel points corresponding to the first search range. For example, the standard surface can be preset, such as a plane or a curve. Next, the calculation component determines a distance difference between the measurement distances of the plurality of target-scene pixel points corresponding to the first search range and the first standard surface, that is, determines a deviation degree between each pixel point and the first standard surface. Then, the calculation component determines the pixel points belonging to the first adjacent local area based on the distance difference and a first distance threshold D_{adjacent}. For example, pixel points having a distance difference smaller than D_{adjacent} are determined to be pixel points belonging to the first adjacent local area. As an example, the value of the first distance threshold D_{adjacent} can be set according to the accuracy requirement of space measuring.

According to another embodiment of the present disclosure, the calculation component can use an artificial intelligence (AI) recognition model to determine the pixel points belonging to the first adjacent local area. Specifically, the calculation component can use a trained AI model or depth recognition model or other recognition models (for example, hidden Markov statistical model (HMM)) to determine the pixel points belonging to the first adjacent local area from the plurality of target-scene pixel points corresponding to the first search range. In this embodiment, the space measuring apparatus can also include an image acquisition component configured to acquire an image of the target scene. Therefore, the calculation component can also determine the pixel points belonging to the first adjacent local area from the plurality of target-scene pixel points corresponding to the first search range based on the artificial intelligence recognition model and the image of the target scene, so as to improve the accuracy of recognizing adjacent local areas.

It should be noted that the process of determining the pixel points belonging to the second adjacent local area is similar to that of the first adjacent local area, which will not be described again here.

According to the embodiments of the present disclosure, the calculation component is also configured to recognize geometry figures based on the plurality of target-scene pixel points corresponding to the first search range using the artificial intelligence recognition model, that is, recognize a basic geometry figure included in the target scene, such as a square, a circle, a triangle, and the like. As an example, based on a large number of 3D images as training data, the recognition ability from a 3D depth point cloud to a geometric figure can be obtained through reverse training. As another example, the recognition model can also be trained or real-time trained according to the measurement data of the space measuring apparatus. In addition, the space measuring apparatus can also include a display component, such as a display, for displaying the geometry figures recognized by the AI model.

According to some embodiments of the present disclosure, the geometry figures include basic graphic elements used in computer graphics systems, games, and/or animations. The basic graphic elements are composed of several different points, lines, plane patterns or repetition of the same pattern. Such points, lines and plane patterns are the basic graphic elements. In other words, basic graphic elements are the basic graphic entities for graphic elements to construct complex geometric figures and figure frames. Different graphic systems have different graphic elements. The GKS standard specifies six basic graphic elements, namely, polyline, multipoint mark, filled area, text, pixel array and GDP (Generalized Drawing Primitive). For example, the basic primitives of the Open Graphics Library (OpenGL) include points, line segments, polygons, triangles, quadrangles, sectors, and so on.

According to some embodiments of the present disclosure, training data of the artificial intelligence recognition model includes real data actually collected and calibrated, or also includes virtual data generated by games and animations. For example, the artificial intelligence recognition model can be trained with the data collected and calibrated in the real scene and/or the virtual data generated in games and animations, to realize the function of recognizing geometric figures as described above.

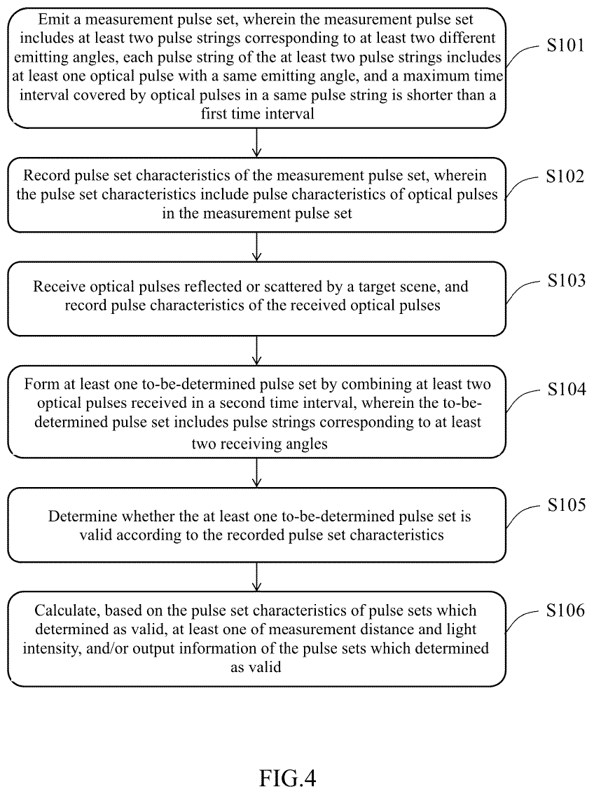

As described above, in the space measuring apparatus according to the embodiments of the present disclosure, a measurement pulse set is emitted by the light emitting component, the measurement pulse set includes at least two pulse strings corresponding to at least two different emitting angles, and each of the pulse strings includes at least one optical pulse with the same emitting angle. A valid pulse set is determined based on the recorded pulse set characteristics of the measurement pulse set. The measurement distance of the pixel points in the current scene is calculated based on the pulse set determined to be valid, so as to achieve anti-interference in the process of space measuring, and improve the measurement accuracy and measurement reliability of the laser radar. On the other hand, according to the present disclosure, a space measuring method is also provided. FIG. 4 shows a flowchart of the space measuring method according to the embodiments of the present disclosure.

First, in step S101, a measurement pulse set is emitted, wherein the measurement pulse set includes at least two pulse strings corresponding to at least two different emitting angles, each of the pulse strings includes at least one optical pulse with the same emitting angle, and the maximum time interval covered by optical pulses in the same pulse strings is shorter than a first time interval.

In step S102, pulse set characteristics of the measurement pulse set are recorded, wherein the pulse set characteristics include pulse characteristics of the optical pulses in the measurement pulse set.

In step S103, optical pulses reflected or scattered by the target scene are received, and the pulse characteristics of the received optical pulses are recorded.

In step S104, at least one to-be-determined pulse set is formed by combining at least two optical pulses received in a second time interval, wherein the to-be-determined pulse set includes pulse strings corresponding to at least two receiving angles.

In step S105, it is determined whether the at least one to-be-determined pulse set is valid according to the recorded pulse set characteristics.

In step S106, at least one of measurement distance and light intensity is calculated based on the pulse set characteristics of pulse sets which are determined as valid, and/or information of pulse sets which are determined as valid is output.

It should be noted that in addition to the above steps S101-S106, the method provided according to the present disclosure can also include other steps to achieve anti-interference. The other steps can refer to the above detailed description of the space measuring apparatus, which will not be repeated here.

According to another aspect of the present disclosure, a space measuring device is also provided. FIG. 5 shows a schematic diagram of a space measuring device 2000 according to embodiments of the present disclosure.

As shown in FIG. 5, the device 2000 can include one or more processors 2010 and one or more memories 2020. The memory 2020 stores computer readable code. The computer readable code, upon executed by the one or more processors 2010, performs the space measurement method described above.

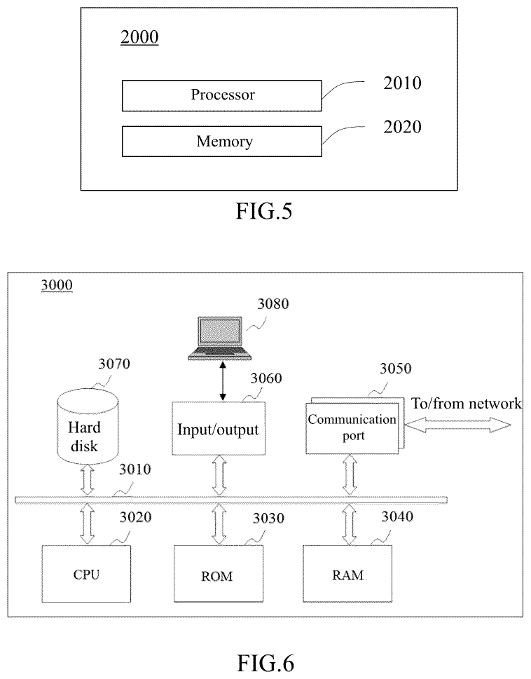

The method or apparatus according to the embodiments of the present disclosure can also be implemented with the architecture of the computing device 3000 shown in FIG. 6. As shown in FIG. 6, the computing device 3000 can include a bus 3010, one or more CPU 3020, a read-only memory (ROM) 3030, a random-access memory (RAM) 3040, a communication port 3050 connected to a network, an input/output component 3060, a hard disk 3070, etc. The storage device in the computing device 3000, such as ROM 3030 or hard disk 3070, can store various data or files used for processing and/or communication of the space measurement method provided in the present disclosure and program instructions executed by the CPU. The computing device 3000 can also include a user interface 3080. However, the architecture shown in FIG. 6 is only exemplary. When implementing different devices, one or more components of the computing devices shown in FIG. 6 can be omitted according to actual needs.

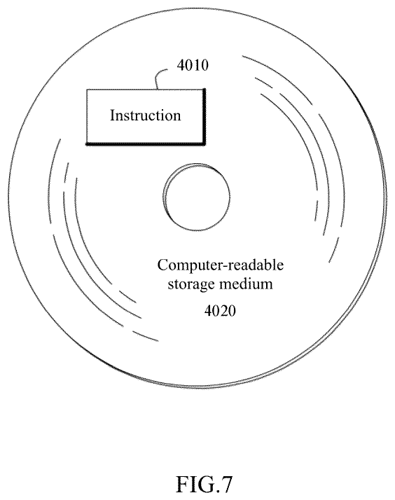

According to another aspect of the present disclosure, a computer-readable storage medium is also provided. FIG. 7 shows a schematic diagram of a storage medium according to the present disclosure.

As shown in FIG. 7, the computer readable instruction 4010 is stored on the computer storage medium 4020. When the computer-readable instruction 4010 is run by a processor, the space measuring method according to the embodiments of the present disclosure described with reference to the above figures can be executed. The computer-readable storage medium includes, but is not limited to, for example, volatile memory and/or non-volatile memory. The volatile memory can include, for example, a random-access memory (RAM) and/or a cache memory. The non-volatile memory can include, for example, a read-only memory (ROM), a hard disk, a flash memory, and the like.

Those skilled in the art can understand that all or part of the steps in the above method can be completed by instructing relevant hardware through a program, and the program can be stored in a computer-readable storage medium, such as a read-only memory, a disk or an optical disk. Alternatively, all or part of the steps of the above embodiments can also be implemented using one or more integrated circuits. Accordingly, each module/unit in the above embodiments can be implemented in the form of hardware or software functional modules. The present disclosure is not limited to the combination of any specific form of hardware and software.

Unless otherwise defined, all terms used herein (including technical and scientific terms) have the same meanings as those commonly understood by ordinary technicians in the field to which this disclosure belongs. It should also be understood that terms such as those defined in the general dictionary should be interpreted as having meanings consistent with their meanings in the context of relevant technologies, and should not be interpreted in an idealized or highly formalized sense, unless explicitly defined here.

The above is a description of this disclosure and should not be considered as a limitation. Although several exemplary embodiments of the present disclosure have been described, those skilled in the art will easily understand that many modifications can be made to the exemplary embodiments without departing from the novel teaching and advantages of the present disclosure. Therefore, all these modifications are intended to be included in the scope of the present disclosure as defined in the claims. It should be understood that the above is a description of the present disclosure, which should not be considered as limited to the specific embodiments disclosed, and the intention to modify the disclosed embodiments and other embodiments is included in the scope of the appended claims. The present disclosure is defined by the claims and their equivalents.

1. A space measuring apparatus, comprising:
a light emitting component comprising at least one light emitting element, configured to emit a measurement pulse set, wherein the measurement pulse set comprises at least two pulse strings corresponding to at least two different emitting angles, each pulse string of the at least two pulse strings comprises at least one optical pulse with a same emitting angle, and a maximum time interval covered by optical pulses in a same pulse string is shorter than a first time interval, and the light emitting component is further configured to record pulse set characteristics of the measurement pulse set, wherein the pulse set characteristics comprise pulse characteristics of optical pulses in the measurement pulse set;
a light receiving component comprising at least one detection element, configured to receive optical pulses reflected or scattered by a target scene, and record pulse characteristics of the received optical pulses; and
a calculation component, configured to:
form at least one to-be-determined pulse set by combining at least two optical pulses received in a second time interval, wherein the to-be-determined pulse set comprises pulse strings corresponding to at least two receiving angles;
determine whether the at least one to-be-determined pulse set is valid according to the pulse set characteristics recorded by the light emitting component; and
calculate, according to the pulse set characteristics of pulse sets which are determined as valid, at least one of measurement distance and light intensity.

2. The apparatus according to claim 1, wherein the pulse characteristics of optical pulses comprise a first characteristic and a second characteristic, wherein
the first characteristic of an optical pulse emitted by the light emitting component comprises an emitting angle and an emitting time;
the first characteristic of an optical pulse received by the light receiving component comprises a receiving angle and a receiving time;
the second characteristic of an optical pulse emitted by the light emitting component and the second characteristic of an optical pulse received by the light receiving component comprises at least one of the following: a waveform, a wavelength, a wavelength-time function, polarization, peak intensity, total energy, spatial light intensity distribution;
the pulse set characteristics further comprise:
a sequence, a relative time and a relative energy among optical pulses in a pulse string to which the optical pulses belong;
a sequence, a relative time and a relative energy among pulse strings in a pulse set to which the pulse strings belong.

3. The apparatus according to claim 2, wherein the light emitting component is further configured to control, except for the emitting angle and the emitting time, the pulse set characteristics of any two measurement pulse sets within a third time interval to be different,
wherein the second time interval is shorter than the third time interval.

4. The apparatus according to claim 2, wherein the light emitting component is further configured to control that a time interval between optical pulses in the same emitting angle is not longer than a fourth time interval, wherein the fourth time interval is shorter than a first percentage of a fifth time interval, and the fifth time interval is a time for the apparatus transceiving an optical pulse in a maximum range.

5. The apparatus according to claim 4, wherein the light emitting component is further configured to control to at least emit within a sixth time interval, pulse strings having difference in at least one of the following second characteristics:
a waveform, a wavelength, polarization,
wherein the sixth time interval is longer than the fifth time interval.

6. The apparatus according to claim 1, further comprising at least one optical scanning component configured to be connected to the light emitting component and/or the light receiving component to drive the light emitting component and/or the light receiving component to scan the target scene.

7. The apparatus according to claim 1, wherein the calculation component is configured to: after the light receiving component receives an optical pulse, search for optical pulses received within the second time interval before receiving said optical pulse and combine the optical pulses to form at least one to-be-determined pulse set; and
determine to-be-determined pulse sets with pulse set characteristics matching the pulse set characteristics recorded by the light emitting component as valid pulse sets.

8. The apparatus according to claim 7, wherein when the at least one to-be-determined pulse set received within the second time interval is determined to be an invalid pulse set, the calculation component is further configured to:
search for optical pulses received within a seventh time interval before receiving said optical pulse and combine the optical pulses to form at least one extended to-be-determined pulse set;
determine to-be-determined extended pulse sets having pulse set characteristics of the to-be-determined extended pulse sets matching the pulse set characteristics recorded by the light emitting component as valid extended pulse sets;
determine a ratio of the valid extended pulse sets to the at least one to-be-determined extended pulse set;
determine, in response to the ratio is smaller than a second percentage, all the extended pulse sets received within the seventh time interval as invalid extended pulse sets; otherwise, accept the valid extended pulse sets,
wherein the seventh time interval is longer than the second time interval.

9. The apparatus according to claim 4, wherein the light emitting component is further configured to control to at least emit within an eighth time interval, pulse strings having difference in at least two of the following second characteristics:
a waveform, a wavelength, polarization,
wherein the eighth time interval is longer than the fifth time interval, and the second characteristics of any two pulse strings during the eighth time interval are different.

10. The apparatus according to claim 2, wherein the light receiving component is further configured to record a waveform of the received optical pulses based on a combination of the following characteristics: a fixed threshold, a peak intensity, a constant ratio timing intensity, a rising edge time point of the fixed threshold, a falling edge time point of the fixed threshold, a time point of the peak intensity, and a rising edge time point of the constant ratio timing intensity.

11. The apparatus according to claim 10, wherein the fixed threshold and the constant ratio timing intensity are adjusted based on a preset attenuation law.

12. The apparatus according to claim 2, wherein the light receiving component is configured to record a waveform of the received optical pulses based on a plurality of optical intensity data sampled at a fixed time interval or a statistical value of the sampled data.

13. The apparatus according to claim 1, wherein the calculation component is further configured to:
determine pixel points belonging to a first adjacent local area from a plurality of target-scene pixel points corresponding to a first search range;
for the pixel points belonging to the first adjacent local area, determine a first matching ratio of optical pulses used to calculate measurement distances of the pixel points to the optical pulses emitted by the light emitting component; and
accept, in response to the first matching ratio is larger than a first ratio threshold, the measurement distances of the plurality of target-scene pixel points in the first search range and the corresponding optical pulses.

14. The apparatus according to claim 13, wherein the calculation component is further configured to:
reject, in response to the first matching ratio is not larger than the first ratio threshold, the measurement distances of the plurality of target-scene pixel points in the first search range and the corresponding optical pulses.

15. The apparatus according to claim 14, wherein the light emitting component is further configured to emit optical pulses to the first search range again to determine the measurement distances of the plurality of target-scene pixel points corresponding to the first search range again.

16. The apparatus according to claim 15, wherein, in response to the first matching ratio is larger than the first ratio threshold, the calculation component is further configured to:
determine pixel points belonging to a second adjacent local area from a plurality of target-scene pixel points corresponding to a second search range, wherein the second search range is larger than the first search range;
for the pixel points belonging to the second adjacent local area, determine a second matching ratio of the optical pulses used to calculate measurement distances of the pixel points to the optical pulses emitted by the light emitting component;
accept, in response to the second matching ratio is larger than a second ratio threshold, the measurement distances of the plurality of target-scene pixel points in the second search range and the corresponding optical pulses; and
reject, in response to the second matching ratio is not larger than the second ratio threshold, the measurement distances of the plurality of target-scene pixel points in the second search range.

17. The apparatus according to claim 13, wherein, for at least one received optical pulse, the calculation component is further configured to output at least one of the following information: corresponding measuring distance, receiving angle, and relative light intensity.

18. The apparatus according to claim 13, wherein the calculation component determining the pixel points belonging to the first adjacent local area comprises:
fitting a first standard plane based on the measurement distances of the plurality of target-scene pixel points corresponding to the first search range;
determining a distance difference between the measurement distances of the plurality of target-scene pixel points corresponding to the first search range and the first standard plane; and
determining the pixel points belonging to the first adjacent local area based on the distance difference and a first distance threshold.

19. The apparatus according to claim 13, wherein the calculation component determining the pixel points belonging to the first adjacent local area comprises:
determining the pixel points belonging to the first adjacent local area from the plurality of target-scene pixel points corresponding to the first search range based on an artificial intelligence recognition model.

20. The apparatus according to claim 19, further comprising an image acquisition component configured to acquire an image of the target scene, wherein the calculation component determining the pixel points belonging to the first adjacent local area further comprises:
determining the pixel points belonging to the first adjacent local area from the plurality of target-scene pixel points corresponding to the first search range based on the artificial intelligence recognition model and the image of the target scene.

21. The apparatus according to claim 19, wherein the calculation component is further configured to:
recognize geometry figures based on the plurality of target-scene pixel points corresponding to the first search range with the artificial intelligence recognition model.

22. The apparatus according to claim 21, wherein the geometry figures comprise basic graphic elements used in computer graphics systems, games and/or animations.

23. The apparatus according to claim 19, wherein training data for the artificial intelligence recognition model comprises real data actually collected and calibrated, or further comprises virtual data generated by games and animations.

24. A space measuring method, comprising:
emitting a measurement pulse set, wherein the measurement pulse set comprises at least two pulse strings corresponding to at least two different emitting angles, each pulse string of the at least two pulse strings comprises at least one optical pulse with a same emitting angle, and a maximum time interval covered by optical pulses in a same pulse string is shorter than a first time interval;
recording pulse set characteristics of the measurement pulse set, wherein the pulse set characteristics comprise pulse characteristics of optical pulses in the measurement pulse set;
receiving optical pulses reflected or scattered by a target scene, and recording pulse characteristics of the received optical pulses;
forming at least one to-be-determined pulse set by combining at least two optical pulses received in a second time interval, wherein the to-be-determined pulse set comprises pulse strings corresponding to at least two receiving angles;
determining whether the at least one to-be-determined pulse set is valid according to the recorded pulse set characteristics; and
calculating, based on the pulse set characteristics of pulse sets which are determined as valid, at least one of measurement distance and light intensity, and/or outputting information of the pulse sets which are determined as valid.

25. A space measuring device, comprising:
a processor; and
a memory with computer-readable code stored thereon, wherein the computer-readable code, when executed by the processor, performs the space measuring method of claim 24.

26. A computer-readable storage medium with instruction stored thereon, wherein the instructions, when executed by a processor, case the processor to perform the space measuring method of claim 24.
